(19) United States
(12) Patent Application Publication
(10) Pub. No.: US 2004/0016134 A1
(43) Pub. Date: Jan. 29, 2004

(54) Handle arrangement for a power tool

(76) Inventors: Thomas Richard Bednar, Pewaukee, WI (US); Thomas Paul James, Oconomowoc, WI (US); Roger Dean Neitzell, North Prairie, WI (US); Troy Charles Thorson, Waukesha, WI (US)

Correspondence Address: MICHAEL BEST & FRIEDRICH, LLP, 100 E WISCONSIN AVENUE, MILWAUKEE, WI, 53202, US

(21) Appl. No.: 10/453,162

(22) Filed: Jun. 3, 2003

Related U.S. Application Data
(63) Continuation-in-part of application No. 10/011,251, filed on Dec. 3, 2001.

(51) Int. Cl. B25G 1/00

(52) U.S. Cl. 30/392; 30/340

(57) ABSTRACT

A power tool, such as a reciprocating saw. The power tool generally includes a spindle for supporting a tool element, a body defining a pivot axis and housing a motor and a drive mechanism driven by the motor, the drive mechanism driving the spindle, the body having a forward end supporting the spindle and a rearward end, and a grip connected to the rearward end of the body for pivoting movement about the pivot axis. The power tool may include a locking assembly for locking the grip in a pivoted position relative to the body and a switch assembly at least partially supported on the grip. The switch assembly is preferably inoperable when the locking assembly is in an unlocked condition, and the locking assembly preferably cannot be moved to the unlocked condition when the switch assembly is in an operating condition.

### RELATED APPLICATIONS

The present application is a continuation-in-part of co-pending application Ser. No. 10/011,251, filed Dec. 3, 2001.

### FIELD OF THE INVENTION

The present invention relates to power tools and, more particularly, to a handle arrangement for a power tool, such as a reciprocating saw.

### BACKGROUND OF THE INVENTION

A power tool, such as a reciprocating saw, generally includes a housing supporting a motor and a drive mechanism. The motor and the drive mechanism operate to drive a spindle and a tool element supported by the spindle. In a typical reciprocating saw, a main operator's handle is integrally formed with the rearward portion of the housing. Generally, the fixed-handle reciprocating saw is gripped by the operator with one hand on the main operator's handle and a second hand on a forward portion of the housing.

### SUMMARY OF THE INVENTION

In some cutting operations, the operator may prefer a different handle position than the position in which the handle was formed with the housing. For example, the operator may prefer a handle orientation which can be altered for different cutting operations, for different work locations and/or for operator comfort. In particular, the operator may desire to pivot the handle about an axis defined by the housing so that the operator can hold the saw in a different and/or more comfortable manner and/or so that the operator can better control the saw.

Also, an operator may be required to operate the saw in a relatively confined area, such as for example, between obstacles or walls. In such applications, because the configuration of the saw is fixed, the operator may not be able to operate the saw effectively because of the obstacles.

The present invention provides, among other things, a handle arrangement for a power tool, such as a reciprocating saw, that alleviates one or more of the above-identified and other problems with existing power tools and reciprocating saws. Generally, in some aspects and in some constructions, the invention provides a reciprocating saw which may include a handle or grip that is pivotable about an axis defined by the body of the saw. The reciprocating saw may include a wiring arrangement electrically connecting a switch assembly and a motor and accommodating pivoting movement of the switch assembly relative to the housing. The reciprocating saw may include a compressible member positioned between the rearward end of the body and an end of the grip to accommodate relative axial movement between the grip and the body. The reciprocating saw may include a ring extending around a portion of the circumference of one of the rearward end of the body and the rearward end of the grip and a sleeve extending around a portion of the circumference of the ring and being between the ring and the rearward end of the body and the second end of the grip.

More particularly, in some aspects and in some constructions, the present invention provides a power tool generally including a spindle for supporting a tool element, a body defining a first axis and housing a motor and a drive mechanism driven by the motor, the drive mechanism selectively driving the spindle, the body having a forward end supporting the spindle and a rearward end, the rearward end defining a plane orientated at a non-perpendicular angle relative to the first axis, and a grip pivotably connected to the rearward end of the body for pivotable movement about a second axis relative to the housing, the second axis extending through the rearward end and being substantially perpendicular to the plane, the grip having a first end and a second end, the first end being engageable by a hand of an operator, the second end being adjacent the rearward end of the body and being oriented in the plane.

Also, in some aspects and in come constructions, the present invention provides a power tool generally including a spindle for supporting a tool element, a body defining an axis and housing a motor and a drive mechanism driven by the motor, the drive mechanism selectively driving the spindle, the body having a forward end supporting the spindle and a rearward end, a grip pivotably connected to the rearward end of the body for pivotable movement about the axis, the grip having a first end and a second end, the first end being engageable by a hand of an operator, the second end being adjacent the rearward end of the body, a switch assembly operable to electrically connect the motor to a power source, at least a portion of the switch assembly being supported on the grip for pivoting movement with the grip, and a wiring arrangement electrically connecting the switch assembly to the motor and accommodating pivoting movement of the switch assembly with the grip and relative to the motor.

In addition, in some aspects and in some constructions, the present invention provides power tool generally including a spindle for supporting a tool element, a body housing a motor and a drive mechanism driven by the motor, the drive mechanism selectively driving the spindle, the body having a forward end supporting the spindle and a rearward end, a grip connected to the rearward end of the body, the grip having a first end engageable by a hand of an operator and a second end adjacent the rearward end of the body, and a compressible member positioned between the rearward end of the body and the second end of the grip to accommodate relative axial movement between the grip and the body.

Also, in some aspects and in some constructions, the present invention provides a power tool generally including a spindle for supporting a tool element, a body housing a motor and a drive mechanism driven by the motor, the drive mechanism selectively driving the spindle, the body having a forward end supporting the spindle and a rearward end, a grip connected to the rearward end of the body for pivoting movement relative to the body, the grip having a first end engageable by a hand of an operator and a second end adjacent the rearward end of the body, a ring extending around at least a portion of the circumference of one of the rearward end of the body and the second end of the grip, and a sleeve extending around at least a portion of the circumference of the ring and being between the ring and the other of the rearward end of the body and the second end of the grip.

Independent features and independent advantages of the present invention will become apparent to those skilled in the art upon review of the following detailed description, claims and drawings.

### BRIEF DESCRIPTION OF THE DRAWINGS

The present invention is further described with reference to the accompanying drawings, which show at least one preferred embodiment of the present invention. However, it should be noted that the invention is explained and illustrated by way of example only. The various elements and combinations of elements described below and illustrated in the drawings can be arranged and organized differently to result in embodiments which are still within the spirit and scope of the present invention. Also, it is understood that the phraseology and terminology used herein is for the purpose of description and should not be regarded as limiting.

In the drawings, wherein like reference numerals indicate like parts:

FIG. 1 is a side view of a power tool, such as a reciprocating saw, including a handle arrangement embodying aspects of the invention;

FIGS. 2A-2D illustrate adjustment of the handle arrangement;

FIG. 3 is an exploded perspective view of a portion of the reciprocating saw shown in FIG. 1;

FIG. 4 is a perspective view of the reciprocating saw shown in FIG. 1 with one handle half removed;

FIG. 5 is a side view of the reciprocating saw shown in FIG. 1 with one handle half removed;

FIG. 6 is a partial cross-sectional side view of an alternative construction of a physical connecting arrangement for a reciprocating saw;

FIGS. 7A-7B illustrate an alternative construction of a reciprocating saw embodying aspects of the invention;

FIGS. 8A-8C illustrate another alternative construction of a reciprocating saw embodying aspects of the invention and including an alternative wiring arrangement;

FIG. 9 is a partial cross-sectional side view of an alternative construction of a locking assembly for a reciprocating saw;

FIGS. 10A-10F illustrate adjustment of the handle arrangement according to yet another alternative construction of the reciprocating saw; and

FIG. 11 illustrates a partial cross section side view of a further construction of a reciprocating saw embodying aspects of the invention.

### DETAILED DESCRIPTION

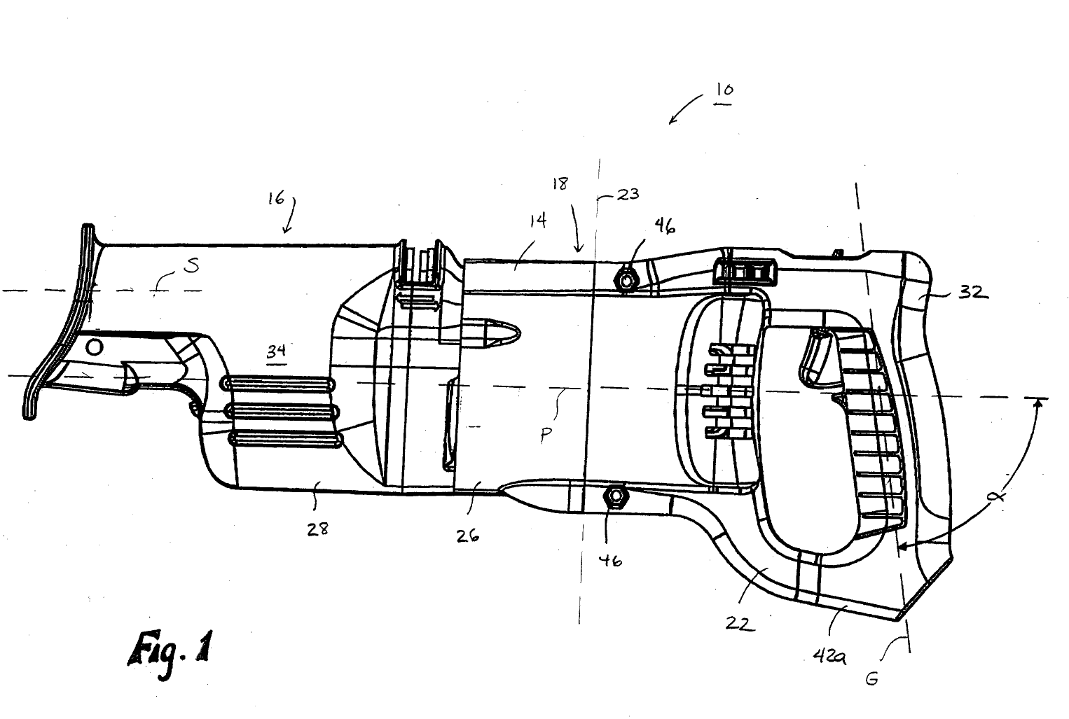

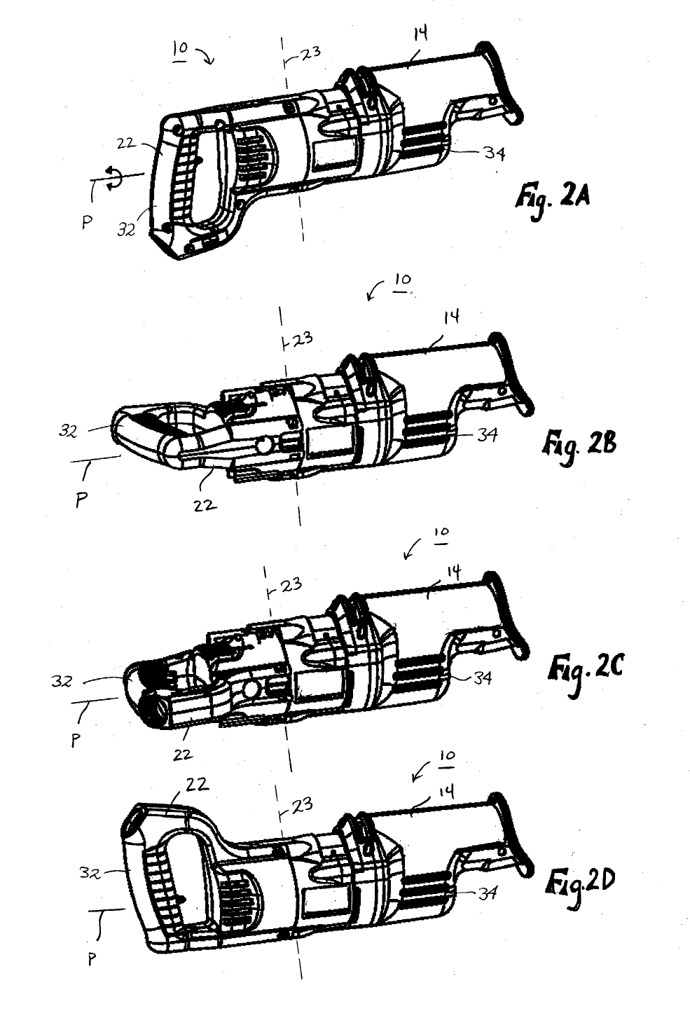

A power tool, such as a reciprocating saw 10, embodying aspects of the invention is illustrated in FIGS. 1 and 2A-2D. The reciprocating saw 10 includes a body 14 having a forward end 16 and a rearward end 18 and a main operator's handle or hand grip 22 pivotably connected to the rearward end 18 of the body 14.

In the illustrated construction and in some aspects, the body 14 defines a pivot axis P, and the grip 22 is pivotable about the pivot axis P between the positions shown in FIGS. 2A-2D. As shown in FIGS. 1 and 2A-2D, in the illustrated construction and in some aspects, the pivot axis P is generally perpendicular to a plane 23 extending between the grip 22 and the rearward end 18 of the body 14.

FIG. 2A illustrates a neutral or normal operating position for the reciprocating saw 10. FIGS. 2B and 2C illustrate 90° pivoted positions, in a first (i.e., clockwise) direction and in a second (i.e., counterclockwise) direction, respectively. FIG. 2D illustrates a 180° pivoted or inverted position of the grip 22 relative to the body 14. The grip 22 is adjustable to the inverted position in both directions from the neutral position. As shown in FIGS. 2A-2D, the grip 22 is pivotably adjustable between pivoted positions (see FIGS. 2A and 2D) in which the grip axis G is generally co-planar with the cutting plane and pivoted positions (see FIGS. 2B and 2C) in which the grip axis G is non-planar with the cutting plane.

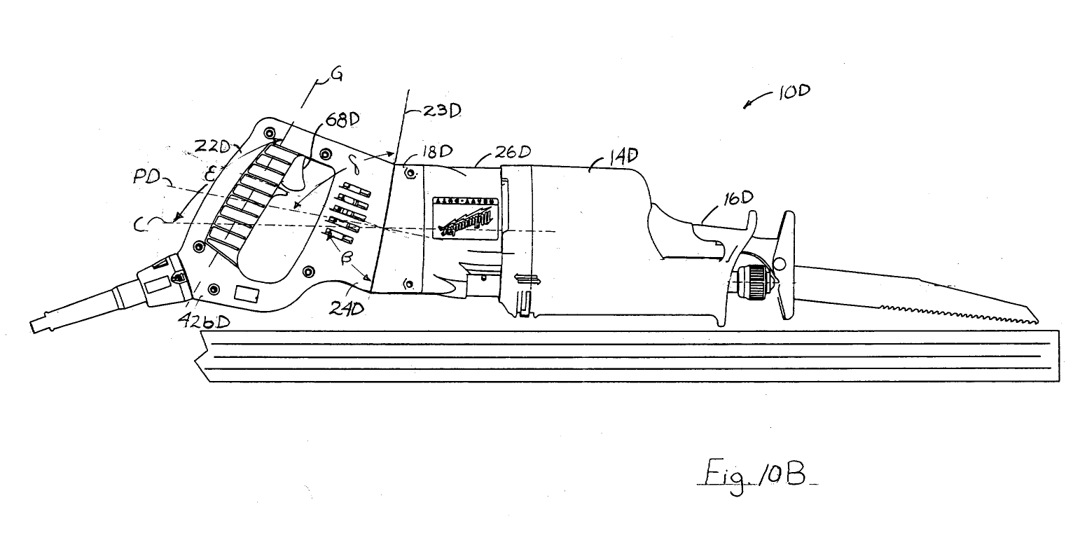

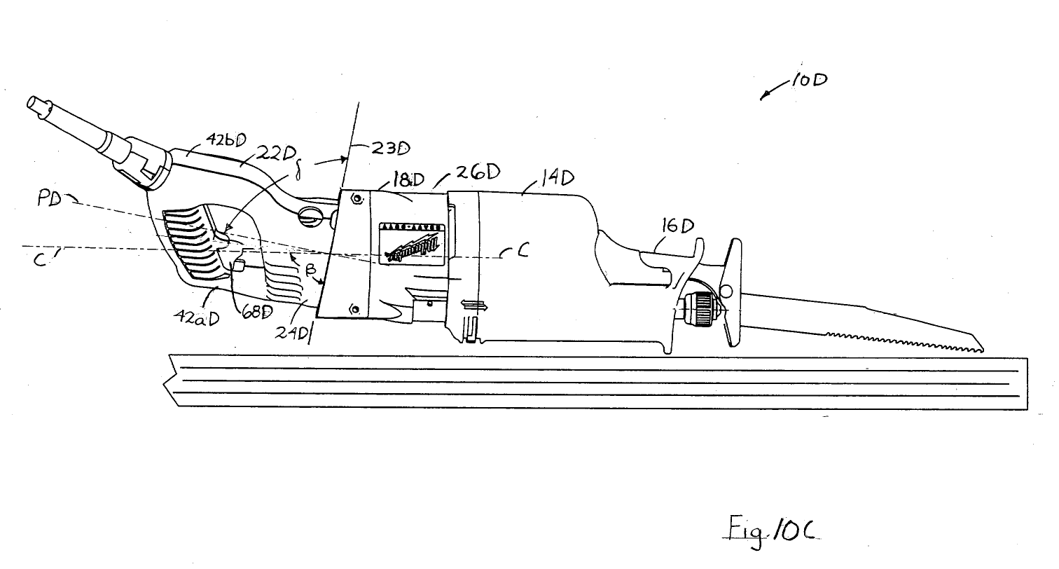

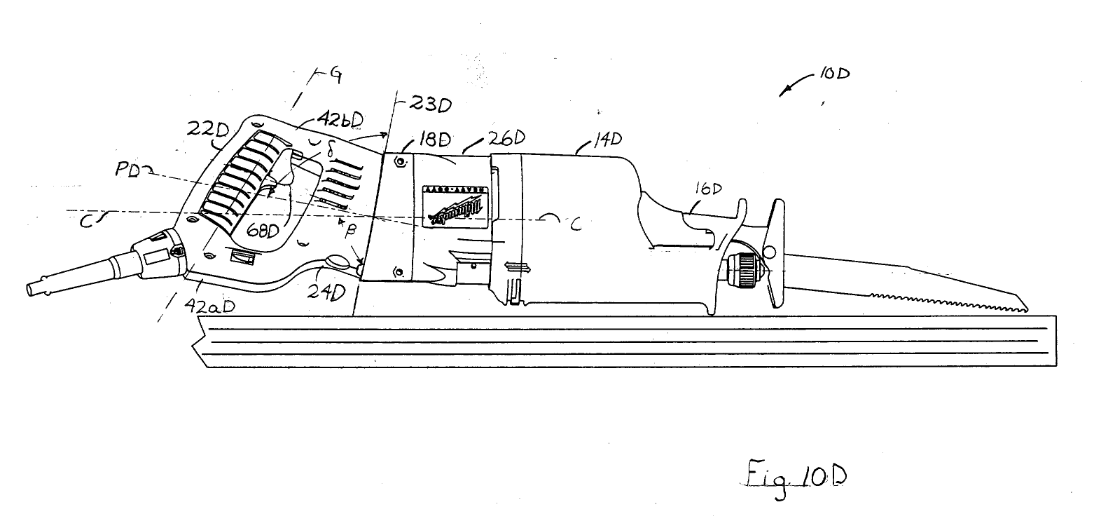

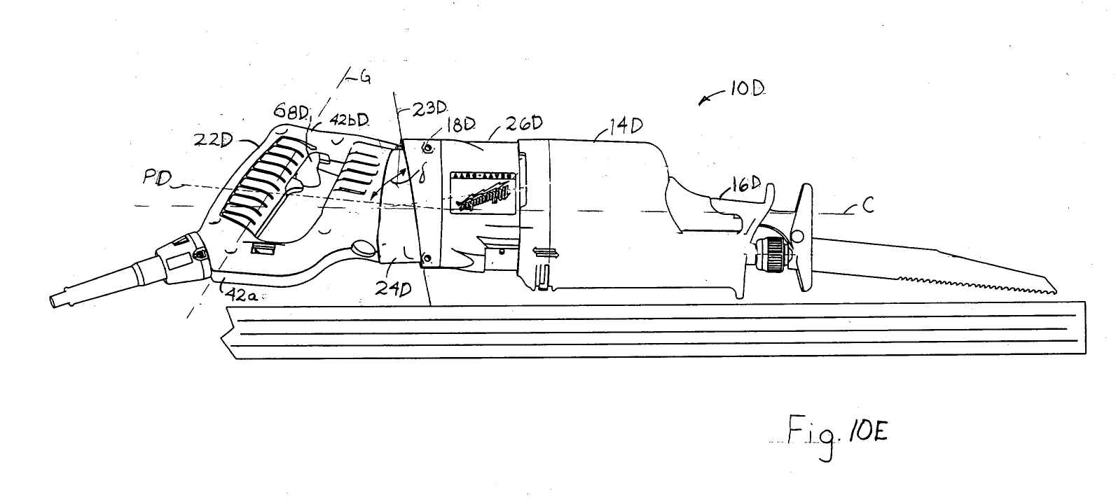

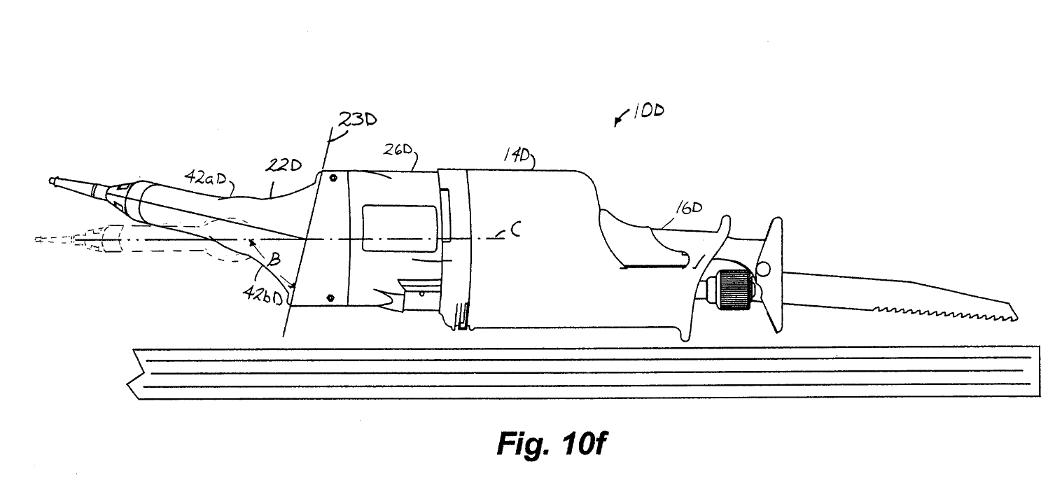

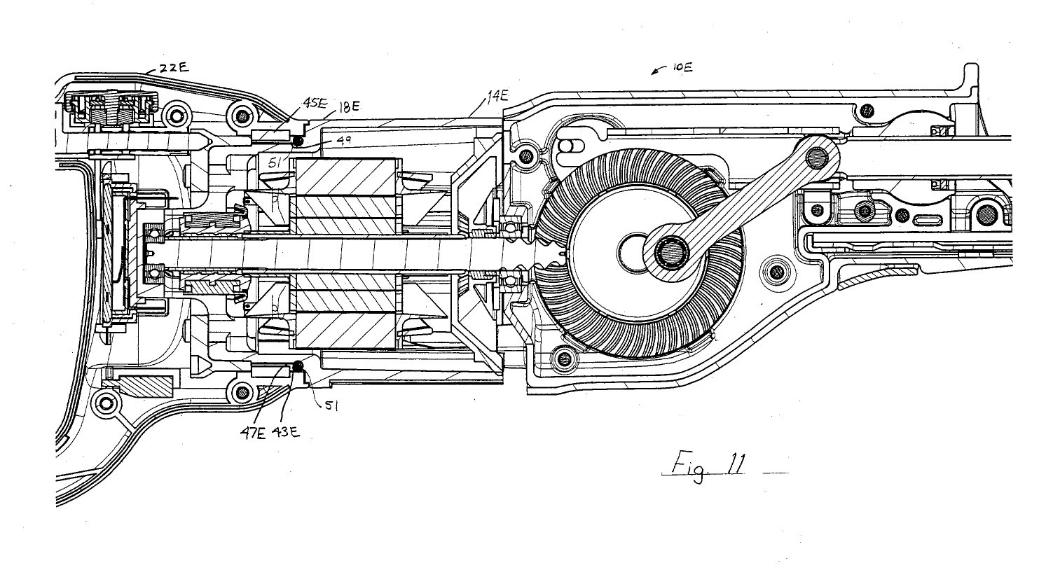

As explained below in more detail, in some constructions and in some aspects, the grip 22 is prevented from pivoting in both directions beyond the inverted position. It should be understood that, in such constructions, the grip 22 is positionable in pivoted positions between the four illustrated pivoted positions. In other constructions, such as, for example, the construction illustrated in FIGS. 10A-10F (described below in more detail), the grip 22 can pivot more than 360° about the pivot axis P in both the first (i.e., clockwise) direction and in the second (i.e., counterclockwise) direction, respectively.

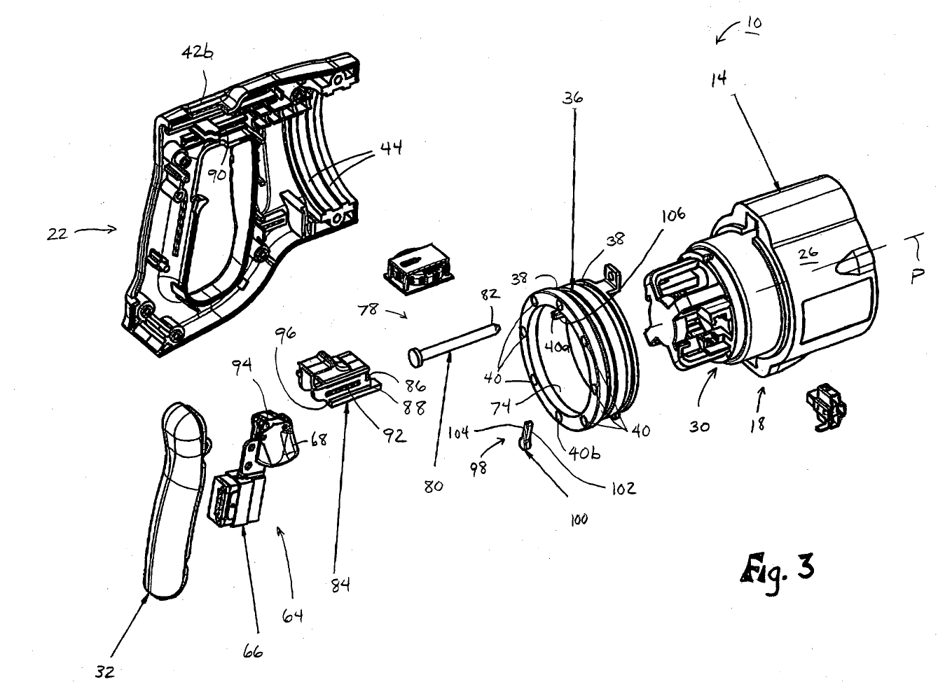

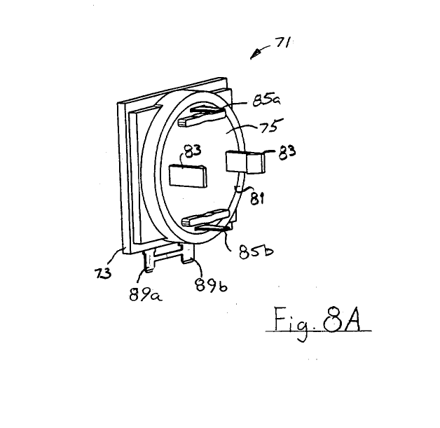

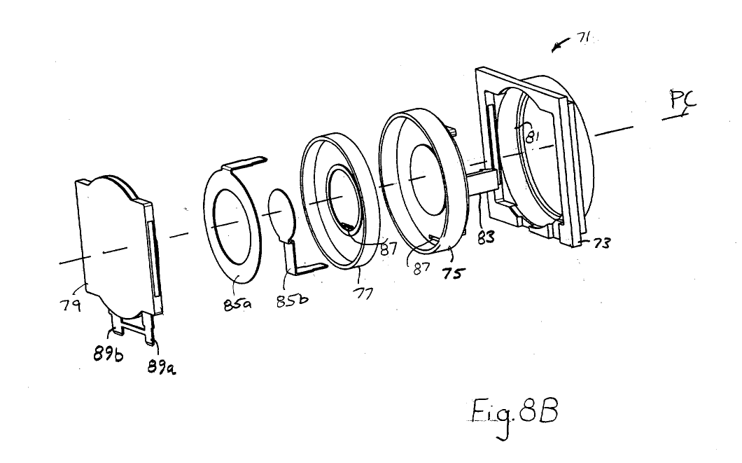

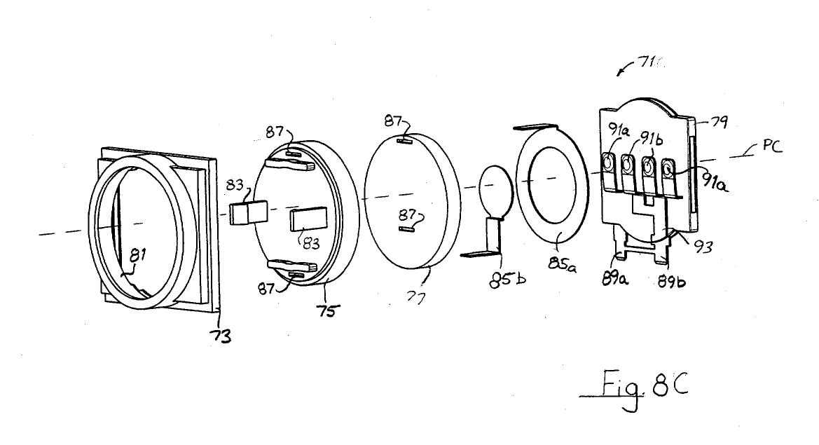

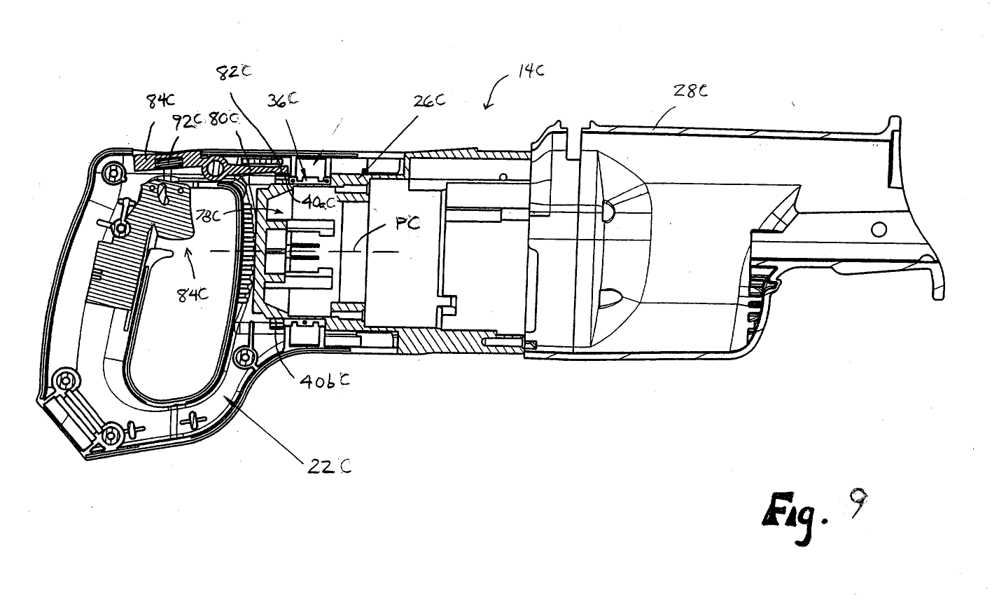

As shown in FIGS. 1 and 3-5, the body 14 is provided by a housing assembly including a motor housing 26 and a gear case 28. In the motor housing 26, the body 14 houses a motor 30 (partially shown in FIGS. 3-5), and, in the gear case 28, the body 14 houses a drive mechanism (not shown but similar to that shown in FIGS. 7A-7B) drivingly connected to the motor 30. While, in the illustrated construction, the body 14 houses both the motor 30 and the drive mechanism, in other constructions (not shown) and in some aspects, the body 14 may house only one or at least one of the motor 30 and the drive mechanism.

The motor 30 and the drive mechanism are operable to reciprocate a spindle (not shown but similar to that shown in FIGS. 7A, 10A-10F and 11) generally along a spindle axis S (shown in FIG. 1). In the illustrated construction, the spindle is supported by the forward end of the body 16 for reciprocating motion and may also be supported for rocking motion or orbital motion relative to the body 14. In the illustrated reciprocating saw 10, the spindle is adapted to support a saw blade (not shown but similar to that shown in FIGS. 10A-10F) for cutting a workpiece (not shown but such as that shown in FIGS. 10A-10F) in a cutting plane defined by the saw blade.

As shown in FIGS. 1-5, the grip 22 is pivotably connected to the rearward end 18 of the body 14 for pivotal movement about the pivot axis P. In the illustrated construction, the grip 22 is a D-shaped handle adapted to be gripped relatively comfortably and securely by one of the operator's hands. In the illustrated construction, a cushion grip 32 (shown in FIGS. 1, 2A-2D and 3-5) is formed on or connected to the grip 22, making the grip 22 relatively more comfortable and/or easy for the operator to hold. In other constructions (not shown), the grip 22 may have a different shape and configuration. For example, the grip 22 may have a pistol-type shape.

The grip 22 has (see FIG. 1) a first end and a second end and defines the grip axis G therebetween. In the construction illustrated in FIGS. 1-6, the grip axis G and the pivot axis P define an angle α, which is generally greater than 0° and which is preferably between 30° and 90°. In the illustrated construction, the grip axis G is substantially perpendicular to the pivot axis P (i.e., the angle α is about 80°). It should be understood that, in other constructions (shown in FIGS. 10A-10F) and in some aspects, the orientation of the axes G and P may be different, such as generally parallel or skew.

As shown in FIGS. 1, 2A-2D and 4-5, the body 14 provides a generally cylindrical forward grip portion 34. The grip portion 34 is located on the forward end 16 of the body 14 and is configured to be held by the operator's other hand in any number of different manners and orientations relative to the body 14. In operation, the operator preferably places one hand on the grip 22 and the other hand on the grip portion 34 to guide and support the reciprocating saw 10 as the reciprocating saw 10 cuts the workpiece.

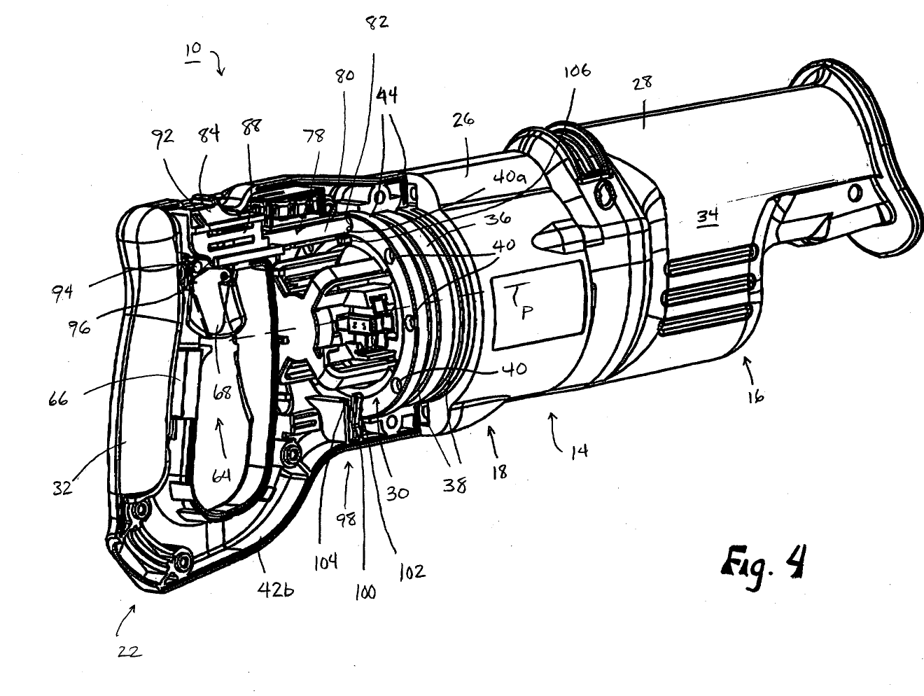

As shown in FIGS. 3-5, in one construction, an inner ring 36 is connected to the rearward end 18 of the body 14, for example, by fasteners (not shown). The inner ring 36 defines at least one and, preferably, two radially-inwardly extending circumferential grooves 38. In the illustrated construction, the grooves 38 extend about the circumference of the inner ring 36. In other constructions (not shown), grooves may extend about only a portion of the circumference of the inner ring 36. On the rearward face, the inner ring 36 defines (see FIGS. 3-4) a plurality of axially-extending, circumferentially-spaced apart 25 recesses 40. It should be understood that, in other constructions (not shown), the inner ring 36 may not be provided, and the structures formed on the inner ring (e.g., the grooves 38 and the recesses 40) may be defined by the rearward end 18 of the body 14.

The grip 22 is formed of two handle halves 42a (shown in FIG. 1) and 42b (shown in FIGS. 3-5). The handle halves 42a and 42b are mirror images, and, therefore, only the handle half 42b will be described in detail. The handle half 42b defines at least one and, preferably, two radially-inwardly extending circumferential projections 44. In the illustrated construction, the projections 44 extend about the circumference of the handle half 42b. In other constructions (not shown), projections may extend about only a portion of the circumference of the handle half 42b.

In the construction illustrated in FIGS. 1-5, the handle halves 42a and 42b sandwich the inner ring 36 and the rearward end 18 of the body 14. The projections 44 are complementary to and engageable with the grooves 38 when the handle halves 42a and 42b are positioned on the inner ring 36 and the rearward end 18 of the body 14. As shown in FIG. 1, fasteners 46 hold the handle halves 42a and 42b in contact with the rearward end 18 of the body 14. In this manner, the grip 22 is axially fixed with but pivotably movable relative to the body 14 about the pivot axis P.

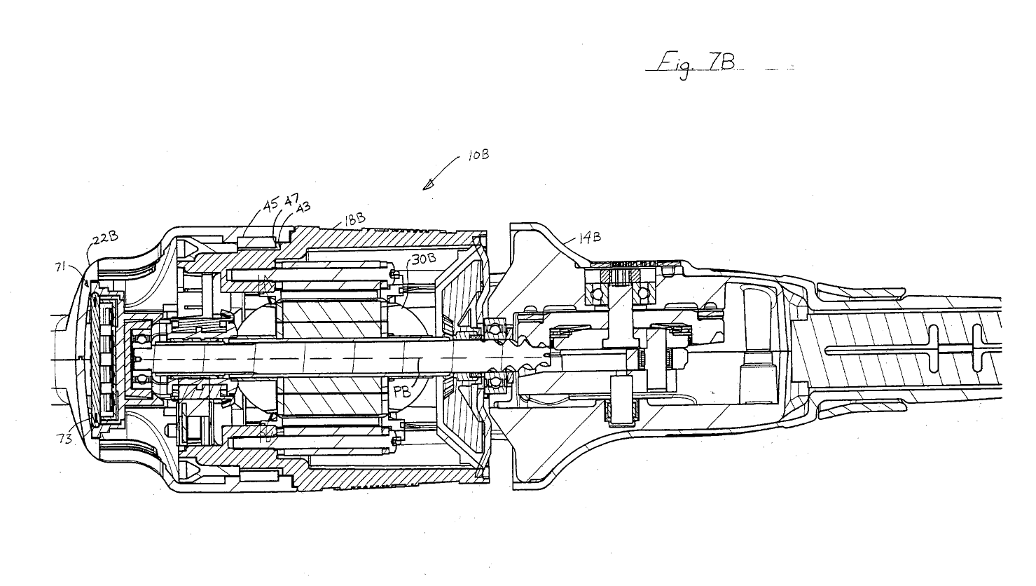

It should be understood that, in other constructions (not shown), grooves (similar to the grooves 38) may be formed on the handle halves 42a and 42b, and projections (similar to the projections 44) may be formed on the inner ring 36 or on the rearward end 18 of the body 14. Also, it should be understood that, in other constructions (such as that shown in FIG. 6 or in FIGS. 7A-7B), another physical connecting arrangement may be provided to maintain the grip 22 and body 14 in engagement.

An alternate construction of a physical connecting arrangement for a reciprocating saw 10A is illustrated in FIG. 6. Common elements are identified by the same reference number “A”.

As shown in FIG. 6, an inner member 48 defining an opening 50 is connected to the body 14A. An outer member 52 defining an opening 54 is connected to the grip 22A, and, when the grip 22A sandwiches the body 14A, the openings 50 and 54 are generally aligned with one another and with the pivot axis PA. An axially-extending connecting member, such as, for example, a bolt 56 extends through the openings 50 and 54 to axially fix the grip 22A and the body 14A. The bolt 56 allows pivotable movement of the grip 22A relative to the body 14A. One or more biasing members, such as, for example, a spring washer 58 or other type of spring or elastomeric member, biases or compresses the grip 22A and the body 14A into close axial engagement. A bearing member, such as, for example, a thrust washer 60, allows relative rotation of the grip 22A and the body 14A. In this manner, the grip 22A is axially fixed with but pivotably movable relative to the body 14A about the pivot axis PA.

Another alternate construction of a physical connecting arrangement for a reciprocating saw 10B is illustrated in FIGS. 7A-7B. Common elements are identified by the same reference number “B”.

As shown in FIGS. 7A-7B, in this construction, a groove 43 is defined by and extends circumferentially around the exterior surface of the rearward end 18B of the body 14B. A ring 45 is held in the groove 43, and a sleeve 47 extends circumferentially around the ring 45 between the rearward end 18B of the body 14B and the grip 22B. To facilitate rotation of the grip 22B relative to the body 14B, one or all of the ring 45, the sleeve 47, and the grip 22B have relatively smooth, low-friction engaging surfaces and are sized to rotate freely about the pivot axis PB with respect to one another and with respect to the rearward end 18B of the body 14B. Together, the ring 45 and the sleeve 47 may also inhibit entry of debris between the grip 22B and the rearward end 18B of the body 14B.

It should be understood that in other constructions (not shown), the circumferentially extending groove 43 may be defined by the grip 22B, and the ring 45 and the sleeve 47 may be supported on grip 22B. In still other constructions (not shown), the ring 45 may be integrally formed with one of the rearward end 18B of the body 14B or the grip 22B.

Referring again to the construction shown in FIGS. 3-5, the motor 30 is an electric motor that is connectable to a power source (not shown) such as, for example, to a separate AC or DC power source by a plug (not shown but connectable to the second end of the grip 22) or to a battery (not shown) supported on the grip 22 or on the body 14. An electrical circuit is operable to connect the motor 30 to the power source. The circuit includes (see FIGS. 3-5) a switch assembly 64 which selectively connects the motor 30 to the power source. In an operating condition, the switch assembly 64 connects the motor 30 to the power source. In a non-operating condition, the switch assembly 64 does not connect the motor 30 to the power source.

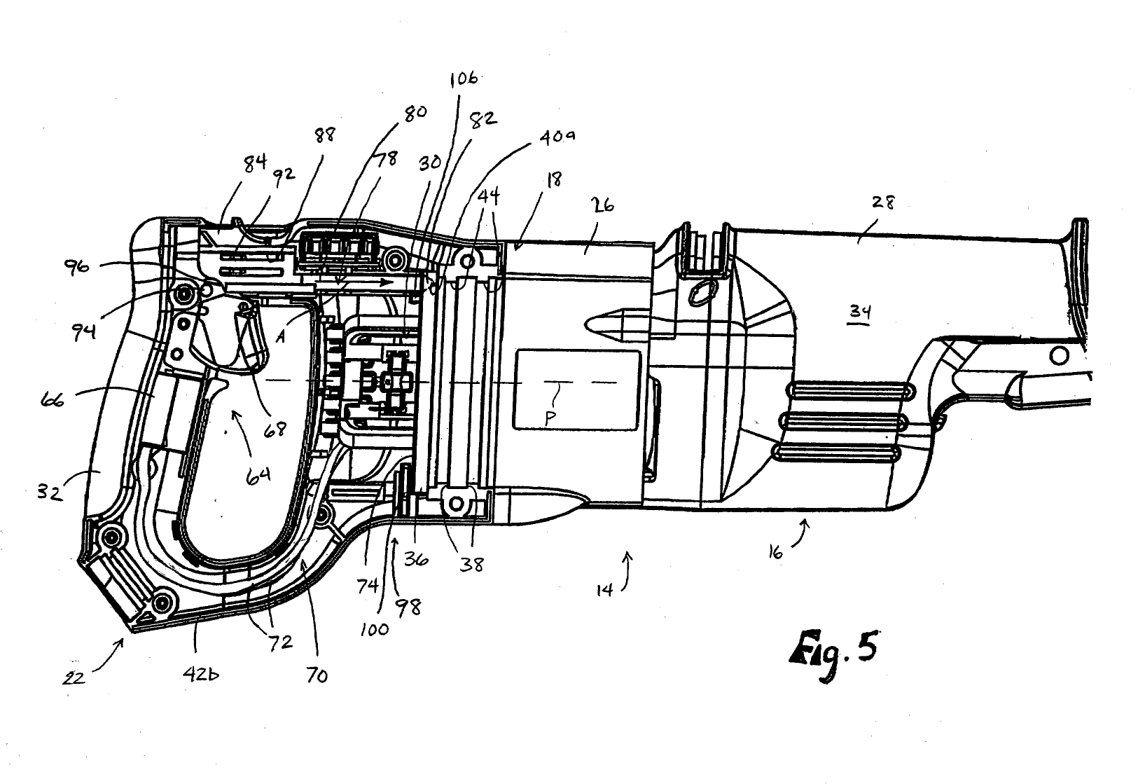

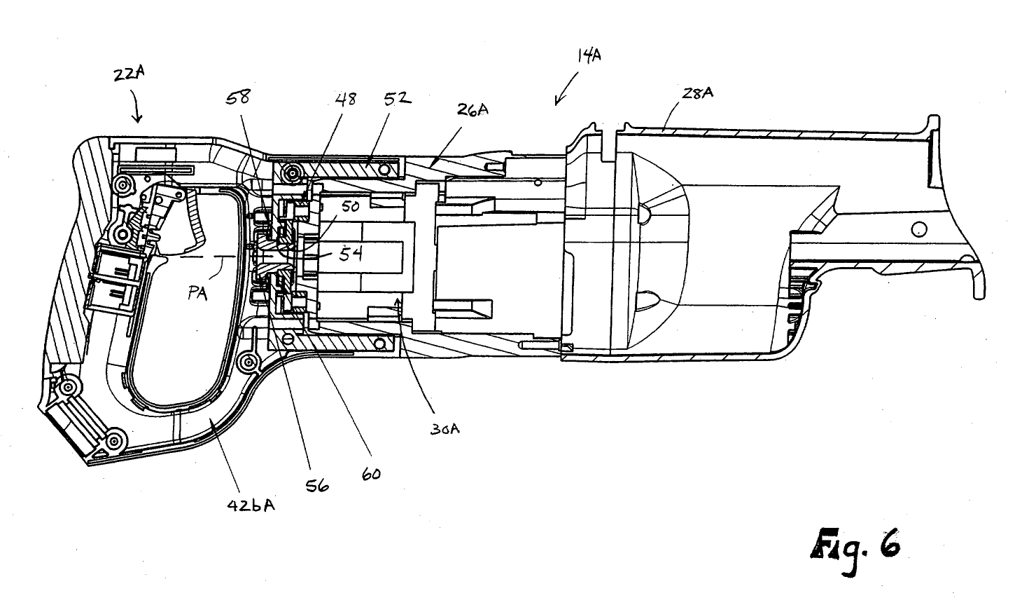

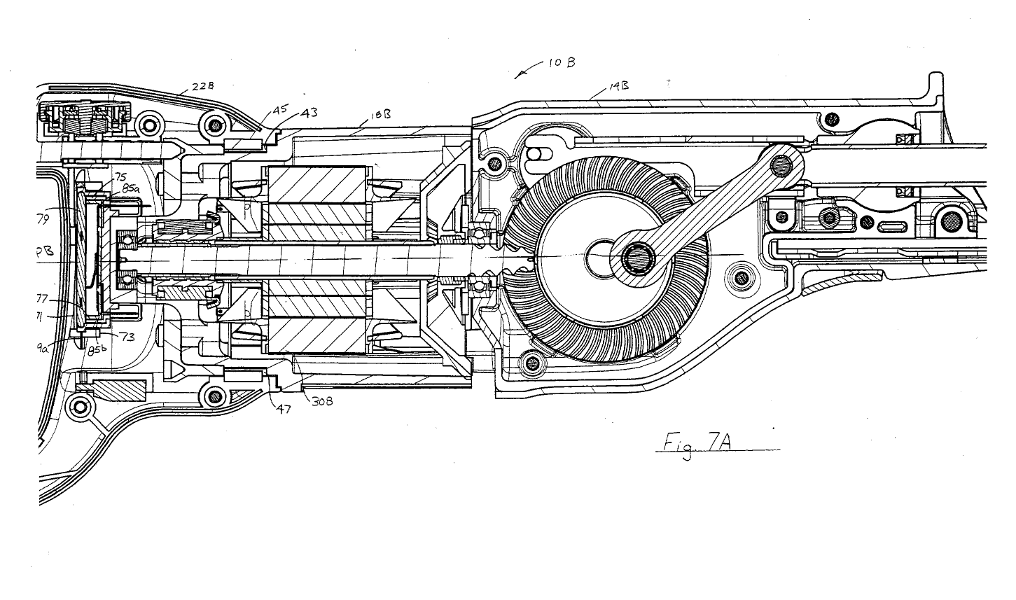

The switch assembly 64 includes an on/off switch 66 and a trigger 68. As shown in FIGS. 4-5, at least a portion of the switch assembly 64 (e.g., the on/off switch 66 and the trigger 68) is supported on the grip 22 and is pivotable with the grip 22 about the pivot axis P.

To accommodate pivoting movement of the on/off switch 66 with the grip 22 about the pivot axis P and relative to the motor 30, the reciprocating saw 10 includes connecting structure, such as, for example, a wiring arrangement 70 (partially shown in FIG. 5). The wiring arrangement 70 includes wires, leads, contacts, etc., which electrically connect the pivotably movable elements of the switch assembly 64, such as the on/off switch 66 and/or the trigger 68, to the motor 30. In the illustrated construction, the wiring arrangement 70 also connects and accommodates pivoting movement of the power source (i.e., a separate source through the plug or a battery supported on the grip 22) relative to the motor 30.

In the construction illustrated in FIGS. 1-5, the wiring arrangement 70 includes wires 72 having a sufficient length and arranged in a manner within the reciprocating saw 10 to accommodate movement of the on/off switch 66 with the grip 22 about the pivot axis P and relative to the motor 30. The wires 72 extend from the on/off switch 66 to a portion of the motor 30 extending through (see FIG. 3) a central opening 74 in the inner ring 36 and are connected to the motor 30 with electrical connectors (not shown), such as leads. The opening 74 is generally aligned with the pivot axis P, and the electrical connections are made relatively near the pivot axis P so that, during pivoting movement of the grip 22, the distance between the on/off switch 66 and the motor 30 remains generally constant.

It should be understood that, in other constructions, different connecting structure may be provided to electrically connect the on/off switch 66 and the motor 30 and to accommodate pivoting movement of the on/off switch 66 relative to the motor 30.

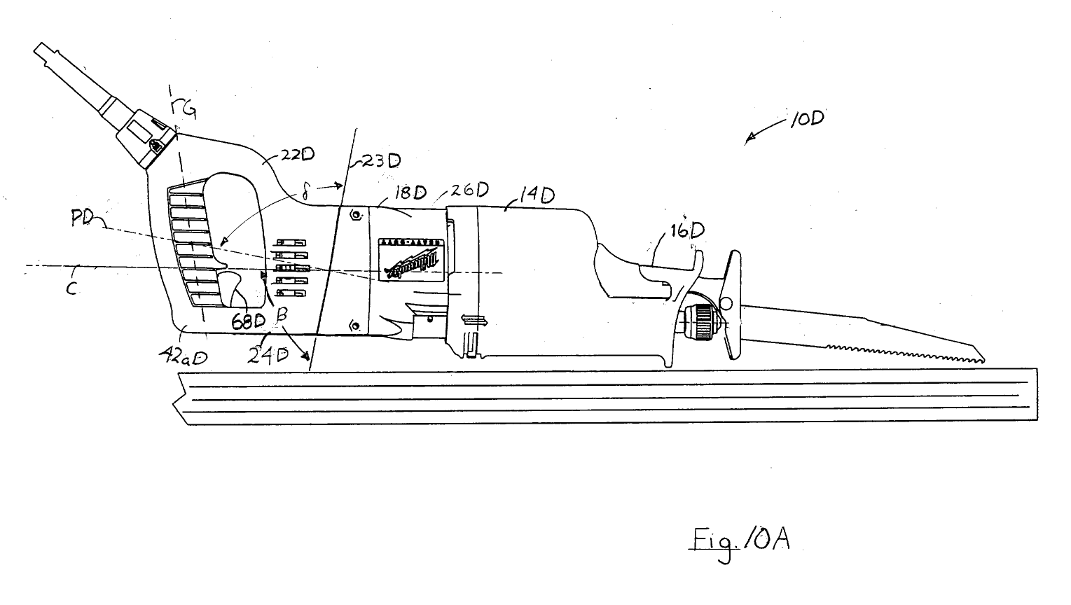

For example, an alternate construction of a connecting structure for the reciprocating saw 10B is illustrated in FIGS. 7A-7B and 8A-8C. Again, common elements are identified by the same reference number “B”.

A fixed electrical connector (for example, contacts 85a, 85b) may be provided on one of the grip 22B and the body 14B (i.e., on the body 14B) and is connected to the associated one of the on/off switch 66 and the motor 30B (i.e., to the motor 30B). The fixed electrical connector includes at least a portion which extends along the path of movement of the grip 22B relative to the body 14B. A movable electrical connector (for example, terminals 91a, 91b) is provided on the other of the grip 22B and the body 14B (i.e., on the grip 22B) and is connected to the associated one of the on/off switch 66 and the motor 30B (i.e., to the on/off switch 66). The movable electrical connector moves along and maintains electrical connection with the fixed electrical connector during pivoting movement of the on/off switch 66 with the grip 22B relative to the motor 30B to maintain the electrical connection between the on/off switch 66 and the motor 30B.

As shown in FIGS. 7A-7B and 8A-8C, a terminal assembly 71 may be provided on one of the grip 22B and the body 14B (i.e., on the body 14B) and is connected to one of the on/off switch 66 and the motor 30B (i.e., to the motor 30B). The terminal assembly 71 includes a frame 73, a first non-conductive ring 75, a second non-conductive ring 77, and a terminal block 79 arranged around the pivot axis PB. The frame 73 defines a central aperture 81, which opens along the pivot axis PB. The first non-conductive ring 75 is positioned in the central aperture 81 and includes protrusions 83 that extend axially through the central aperture 81 and matingly engage corresponding apertures (not shown) in one of the grip 22B and the rearward end 18B of the body 14B (i.e., on the rearward end 18B of the body 14B), non-rotatably connecting the first non-conductive ring 75 and the one of the body 14B and the grip 22B (i.e., the rearward end 18B of the body 14B). The second non-conductive ring 77 is positioned inside a circumferential inner surface of and rotatably engages the first non-conductive ring 75. First and second electrical contacts 85a, 85b are arranged between the terminal block 79 and the second non-conductive ring 77 and extend axially through apertures 87 in the first and second non-conductive rings 75, 77. Conductors (not shown) extend between and electrically connect the motor 30B and the first and second electrical contacts 85a, 85b.

The terminal block 79 is fixedly coupled to one of the grip 22B and the rearward end 18B of the body 14B (i.e., the grip 22B) and includes a number of electrical leads 89a, 89b (two are shown in FIGS. 8A-8C) and a number of electrical terminals 91a, 91b (four are shown in FIG. 8C). The protrusions 83, extend along the pivot axis PB into one of the rearward end 18B of the body 14B and the grip 22B (i.e., into the rearward end 18B of the body 14B) and are matingly received in corresponding apertures (not shown) to pivotably connect the terminal assembly 71 and one of the grip 22B and the rearward end 18B of the body 14B (i.e., the rearward end 18B of the body 14B). Conductors 93 (only one shown in FIG. 9C) extend between and electrically connect the electrical leads 89a, 89b and the electrical terminals 91a, 91b, respectively. The electrical leads 89a, 89b are electrically connected to the switch assembly 64 via wires (not shown). The electrical terminals 91a, 91b extend axially from the terminal block 79 in a direction generally parallel to the pivot axis PB and electrically engage the first and second electrical contacts 85a, 85b, respectively.

In another construction (not shown), the connecting structure may include a remote transmitter and sensor combination to connect the on/off switch 66 to the motor 30. In such a construction, the transmitter is fixed to and moves with the grip 22. The transmitter transmits a signal based on the condition of the on/off switch 66, for example, an “ON” signal or an “OFF” signal. The sensor or receiver is mounted on the body 14 and electrically connected to the motor 30. The sensor senses the transmitted signal and, if, for example, the “ON” signal is transmitted, connects the motor 30 to the power source. In such a construction, the power source is directly connectable to the motor 30, rather than being connected to the motor 30 through the switch assembly 64.

It should be understood that, in the illustrated constructions and in other constructions (not shown), the connecting structure (shown in FIGS. 3-5 and in FIGS. 7A-7B and 8A-8C) may be substituted for one another and may be provided in constructions in which the connecting structure is not illustrated in detail.

Referring again to the construction illustrated in FIGS. 3-5, the reciprocating saw 10 also includes a locking assembly 78 for locking the grip 22 in a pivoted position relative to the body 14. As explained in more detail below, the locking assembly 78 is operable between a locked condition, in which the grip 22 is fixed in a pivoted position relative to the body 14, and an unlocked condition, in which the grip 22 is pivotable about the pivot axis P relative to the body 14.

In the illustrated construction, the locking assembly 78 includes a detent arrangement between the grip 22 and the body 14 to provide a positive locking engagement between the grip 22 and the body 14. The locking assembly 78 includes a first locking member or a locking pin 80 having a tapered locking projection 82. The locking projection 82 is selectively engageable in a second locking member (provided by one of the recesses 40 in the rearward face of the inner ring 36) to lock the grip 22 in a pivoted position relative to the body 14. The recesses 40 are tapered and are sized to receive the locking projection 82. The corresponding taper of the locking projection 82 and the recesses 40 substantially eliminates any unintended pivotal motion of the grip 22 about the pivot axis P relative to the body 14 caused by manufacturing tolerances in and/or wear of either the locking pin 80 or the recesses 40.

The locking projection 82 is engageable in a first recess 40a to lock the grip 22 in a first pivoted position relative to the body 14 (i.e., the neutral position shown in FIG. 2A) and in a second recess 40b to lock the grip 22 in a second pivoted position relative to the body 14 (i.e., the inverted position shown in FIG. 2D). The locking projection 82 is engageable in one of the other recesses 40 to lock the grip 22 in a corresponding pivoted position relative to the body 14. In the illustrated construction, the recesses 40 are spaced apart 45° about the circumference of rearward face of the inner ring 36 and provide corresponding 45° spaced apart locked pivoted positions of the grip 22 relative to the body 14.

The locking assembly 78 also includes (see FIGS. 3-5) an actuator 84 to move the locking pin 80 from the locked position (shown in FIGS. 4-5 and in the direction of arrow A in FIG. 5) to the unlocked position (not shown but in the direction opposite to arrow A). In the illustrated construction, the locking pin 80 is slidable along an axis generally parallel to the pivot axis between the locked position and the unlocked position. The actuator 84 defines an opening 86 in which the locking pin 80 is supported, and (see FIG. 3) axial grooves 88 defined on the actuator 84 cooperate with axial projections 90 on the handle halves 42a and 42b to guide the actuator 84 during movement between the locked position and the unlocked position. A biasing member, such as a spring 92, biases the actuator 84 in the direction of arrow A and, thereby, biases the locking member 80 toward the locked position. The locking assembly 78 is thus biased toward the locked condition.

To move the grip 22 relative to the body 14, the actuator 84 is operated (moved in the direction opposite to arrow A) to move the locking projection 82 out of engagement with the selected recess 40 to the unlocked position. While holding the actuator 84, the grip 22 is then moved relative to the body 14 to a position corresponding to engagement of the locking projection 82 with another one of the recesses 40. When the grip 22 is in the desired position, the actuator 84 is released, and the locking projection 82 is moved by the spring 92 into the selected recess 40 to lock the grip 22 in the selected pivoted position relative to the body 14. If the actuator 84 is released during pivoting of the grip 22, the spring 92 will cause the locking projection 82 to engage the rearward face of the inner ring 36 until the locking projection 82 is aligned with a recess 40.

It should be understood that, in other constructions (such as that shown in FIGS. 7A-7B), the components of the locking assembly 78 may move in a different manner, such as, for example, radially (as shown in FIG. 9), tangentially, circumferentially, etc., or may move in a different manner, such as, for example, pivotable movement (as shown in FIG. 9), rotatable movement, radially slidable movement, etc., between the locked condition and the unlocked condition of the locking assembly 78.

Also, in other constructions (not shown), the locking assembly 78 may include a different locking arrangement, such as, for example, a frictional engagement between the grip 22 and the body 14. In such a construction, the locking assembly 78 may be provided by the handle halves 42a and 42b (or similar structure) releasably applying a clamping force to the body 14. An actuating member, such as, for example, the fasteners which connect the handle halves 42a and 42b, selectively move the clamping members between a locked position and an unlocked position corresponding to the locked condition and the unlocked condition, respectively, of the locking assembly 78. In such a construction, the locking assembly 78 may also include a positive engagement arrangement, such as interengaging teeth (not shown) formed on the body 14 and the grip 22 which are engaged when the clamping force is applied.

An alternative construction of a locking assembly 78C for a reciprocating saw 10C is illustrated in FIG. 9. Common elements are identified by the same reference number

As shown in FIG. 9, the first locking member and the locking projection 82C are provided on the forward end of the actuator 84C. The locking projection 82C is selectively engageable in one of the recesses 40C (which are defined on the rearward end of the inner ring 36C and which extend radially-inwardly) to lock the grip 22C in a pivoted position relative to the body 14C. The actuator 84C is pivotable to move the locking projection 82C into and out of engagement with the recesses 40C (between the locked position and the unlocked position, respectively). The spring 92C biases the actuator 84C and, thereby, biases the locking projection 82C toward the locked position (into engagement with one of the recesses 40C).

It should be understood that, in the illustrated constructions and in other constructions (not shown), the locking assemblies 78 and 78C (shown in FIGS. 3-5 and in FIG. 9) may be substituted for one another and may be provided in constructions in which the locking assembly is not illustrated in detail.

Referring again to the construction illustrated in FIGS. 3-5, in some constructions and in some aspects, the reciprocating saw 10 also includes structure to prevent the switch assembly 64 from connecting the motor 18 to the power source when the locking assembly 78 is in the unlocked condition. In addition, the reciprocating saw 10 includes structure to prevent the locking assembly 78 from being operated from the locked condition to the unlocked condition when the switch assembly 64 is in the operated condition. The locking assembly 78 and the switch assembly 64 interact to prevent unintentional operation of one assembly when the other assembly is being operated.

The trigger 68 and the actuator 84 include respective blocking portions 94 and 96. When the switch assembly 64 is in the operating condition, the trigger 68 is pivoted so that the blocking portion 94 on the trigger 68 extends into the path of the actuator 84 and prevents the actuator 84 from moving rearwardly to move the locking pin 80 to the unlocked position. The position of the blocking portion 94 when the switch assembly 64 is in the operating condition thus prevents the locking assembly 78 from being operated to the unlocked condition.

Similarly, when the locking assembly 78 is in the unlocked condition, the actuator 84 is moved rearwardly so that the blocking portion 96 on the actuator 84 extends into the path of the trigger 68 and prevents the trigger 68 from pivoting to a position corresponding to the “ON” position of the on/off switch 66 (and to the operating condition of the switch assembly 64). The position of the blocking portion 96 when the locking assembly 68 is in the unlocked condition thus prevents the switch assembly 64 from being operated to the operating condition from the non-operating condition. Therefore, the switch assembly 64 (and the motor 30) is inoperable when the locking assembly 78 is in the unlocked condition.

It should be understood that, in other constructions (such as that shown in FIG. 9), the blocking or preventing structure may operate in a different manner. Also, different structures may be provided to prevent operation of one of the assemblies 64 or 78 when the other assembly is being operated. In addition, in other constructions (not shown), structure may be provided to prevent only one of the assemblies 64 and 78 from operating when the other is being operated.

As shown in FIGS. 2A-2D, the grip 22 is pivotable approximately 360° about the pivot axis P. However, in some constructions, the grip 22 cannot be pivoted more than 360° to prevent, among other things, the wires 72 from being entangled or over extended. To prevent such over-pivoting of the grip 22, in some constructions and in some aspects, the reciprocating saw 10 includes (see FIGS. 3-5) a pivot-limiting assembly 98 for limiting pivoting movement of the grip 22 relative to the body 14 from a first pivoted position beyond a second pivoted position.

In the construction illustrated in FIGS. 3-5, the pivot-limiting assembly 98 limits pivoting movement of the grip 22 relative to the body 14 from the inverted position (shown in FIG. 2D), around 360° and beyond the inverted position. In other words, in the illustrated construction, the grip 22 is pivotable to the inverted position (shown in FIG. 2D) in either direction but not beyond the inverted position.

The pivot-limiting assembly 98 includes (see FIGS. 3-5) a first pivot-limiting member or stop cam 100 supported by the grip 22 for slight pivoting movement. The stop cam 100 has spaced apart stop surfaces 102 and 104. The stop cam 100 is engageable with a second pivot-limiting member or stop tab 106 defined on the inner ring 36 to prevent movement of the grip 22 relative to the body 14 beyond the inverted position in either direction.

When the grip 22 is pivoted in a first direction (i.e., from the position shown in FIG. 2B to the inverted position shown in FIG. 2D), the stop cam 100 pivots slightly in the same direction to a first pivot-limit position upon engagement of the stop tab 106 with the first stop surface 102. This pivoting movement of the stop cam 100 allows the grip 22 to pivot to the inverted position in the first direction.

When the grip 22 is pivoted in a second direction opposite to the first direction (i.e., from the position shown in FIG. 2C to the inverted position shown in FIG. 2D), the stop cam 100 pivots slightly in the same direction to a second pivot-limit position upon engagement of the stop tab 106 with the second stop surface 104. This pivoting movement of the stop cam 100 allows the grip 22 to pivot to the inverted position in the second direction.

It should be understood that, in other constructions (not shown), the pivot-limiting assembly 98 may limit pivoting movement beyond another pivoted position. Also, in other constructions (not shown), the pivot-limiting assembly 98 may limit pivoting movement of the grip 22 to less than 360° or to a limit greater than 360°. In addition, in other constructions (not shown), the pivot-limiting assembly 98 may include other components and/or the components may interact in other ways to prevent pivoting movement of the grip 22 beyond the desired pivot limits. In other constructions and in other aspects, the pivot-limiting assembly 98 may be provided to limit pivoting movement of two other relatively pivotable structures, such as, for example, a motor housing and a gear case.

In some constructions, such as that shown in FIGS. 7A-7B and 8A-8C, no pivot-limiting assembly is provided, and pivoting movement of the grip 22B is not limited. The grip 22B is pivotable more than 360° in both directions about the pivot axis PB. In such a construction, pivotable electrical transmitting elements (e.g. a terminal assembly 71) electrically connect the motor 30B, which is housed in the body 14B, and one or both of the power source (not shown) and the switch assembly 64B. Moreover, because such constructions operate without wires (such as the wires 72), when the grip 22B is pivoted about a pivot axis PB and with respect to the rearward end 18B of the body 14B, the electrical conducting elements are not twisted or tangled.

An alternative construction of a reciprocating saw 10D is illustrated in FIGS. 10A-10F. Common elements are identified by the same reference number “D”.

As shown in FIGS. 10A-10F, the body 14D defines a central axis C, and the rearward end 18D of the body 14D defines a plane 23D, which is orientated at a non-perpendicular angle (e.g., between about 10° and about 45°) β relative to the central axis C. In the construction illustrated in FIGS. 10A-10F, the pivot axis PD extends through the grip 22D and intersects the plane 23D at a non-perpendicular angle δ. A forward end 24D of the grip 22D contacts the rearward end 18D of the body 14D along the plane 23D and is pivotable about the pivot axis PD between a number of positions relative to the rearward end 18D of the body 14D.

In the construction illustrated in FIGS. 10A-10F, the grip 22D is pivotably adjustable toward a neutral or normal operating position so that the grip axis G is generally co-planar with the cutting plane (see FIG. 10A). Also, the grip 22D is pivotably adjustable between pivoted positions (see FIGS. 10B-10F) in which the grip axis G is non-planar with the cutting plane. In addition, in the pivoted positions the plane 23D of the rearward end 18D of the housing 14D is non-perpendicular to the plane of the saw blade.

FIG. 10A shows a neutral or normal operating position of the reciprocating saw 10D. FIGS. 10B-10F illustrate other operating positions in which the grip 22D is oriented in a number of alternate positions around the pivot axis PD. In particular, in the orientation illustrated in FIG. 10B, the grip axis G is at an angle ε with respect to the center axis C so that the lower most portion of the grip 22D extends rearwardly from the rearward end 18D of the body 14D. More particularly, when the reciprocating saw 10D is in the orientation illustrated in FIG. 10B, the lowermost portion of the grip 22D extends a relatively short distance below the center axis C (as compared with the orientation shown in FIG. 2D) so that the operator can move the reciprocating saw 10D into a position substantially parallel to the work piece. In this manner, the operator can pivot the grip 22D to better engage a work piece with the reciprocating saw 10E and/or work around obstructions (e.g., walls, fasteners, conduit, etc.).

Additionally, an operator can pivot the grip 22D toward any one of a number of positions around the pivot axis PD so that the operator can more effectively and/or more comfortably hold the grip 22D, such as, for example, for overhead cutting operations. In a similar manner and as shown in FIG. 10F, the operator can pivot the grip 22D toward a more comfortable configuration for side cutting operations. In the construction and the pivoted position illustrated in FIG. 10F, an operator can hold the grip 22D with a relatively less extreme wrist position during side cutting operations because the grip 22D is angled rearwardly and inwardly toward the operator's body.

In the illustrated construction, the engagement between the grip 22D and the rearward end 18D of the body 14D provides a generally linear adjustment of the orientation of the grip 22D relative to the body 14D as the grip 22D is pivoted relative to the body 14D. It should be understood that, in other constructions (not shown), the engagement between the grip 22D and the rearward end 18D of the body 14D may provide a non-linear adjustment of the orientation of the grip 22D relative to the body 14D as the grip 22D is pivoted relative to the body 14D.

It should be understood that, in the illustrated constructions and in other constructions (not shown), the engagement between the grip and the body shown in FIGS. 1-9 and 11 and that shown in FIGS. 10A-10F may be substituted for one another.

Another alternate construction of a physical connecting arrangement for a reciprocating saw 10E is illustrated in FIG. 11. Common elements are identified by the same reference number “E”.

As shown in FIG. 11, in this construction, a groove 43E is defined by and extends circumferentially around the exterior surface of the rearward end 18E of the body 14E. A ring 45E is held in the groove 43E, and a sleeve 47E extends circumferentially around the ring 45E between the rearward end 18E of the body 14E and the grip 22E. Together the ring 45E and the sleeve 47E inhibit entry of debris between the grip 22E and the rearward end 18E of the body 14E.

A space 49 is defined between the grip 22E, the sleeve 47E, and the rearward end 18E of the body 14E. In the illustrated construction, a compressible member 51, such as, for example, an o-ring, is positioned in the space 49E to provide limited axial movement between the grip 22E and the rearward end 18E of the body 14E to absorb vibration/impacts and to improve operator comfort. It should be understood that in other constructions, other compressible members (e.g., springs, spring washers, Belleville washers, and etc.) can also be used to provide vibration-isolation between the grip 22E and the rearward end 18E of the body 14E. The compressible member 51 may also inhibit entry of debris between the grip 22E and the rearward end of the body 14E.

It should be understood that, in the illustrated constructions and in other constructions (not shown), the physical connecting arrangements (shown in FIGS. 3-5, in FIG. 6, in FIGS. 7A-7B and in FIG. 11) may be substituted for one another and may be provided in constructions in which the physical connecting arrangement is not illustrated in detail.

The embodiments described above and illustrated in the drawings are presented by way of example only and are not intended to limit the concepts and principles of the present invention. As such, it will be appreciated by one having ordinary skill in the art, that various changes in the elements and their configuration and arrangement are possible without departing from the spirit and scope of the present invention as set forth in the claims.

What is claimed is:

1. A power tool comprising:
a spindle for supporting a tool element;
a body defining a first axis and housing a motor and a drive mechanism driven by the motor, the drive mechanism selectively driving the spindle, the body having a forward end supporting the spindle and a rearward end, the rearward end defining a plane orientated at a non-perpendicular angle relative to the first axis; and
a grip pivotably connected to the rearward end of the body for pivotable movement about a second axis relative to the housing, the second axis extending through the rearward end and being substantially perpendicular to the plane, the grip having a first end and a second end, the first end being engageable by a hand of an operator, the second end being adjacent the rearward end of the body and being oriented in the plane.

2. The power tool of claim 1, wherein the power tool is a reciprocating saw.

3. The power tool of claim 1, wherein the non-perpendicular angle is between about 10 degrees and about 45 degrees relative to the first axis.

4. The power tool of claim 1, further comprising a battery supported by the grip, the battery being electrically connectable to the motor to supply power to the motor.

5. The power tool of claim 1, wherein the grip is a D-shaped handle.

6. The power tool of claim 1, further comprising:
a switch assembly operable to electrically connect the motor to a power source, at least a portion of the switch assembly being supported on the grip for pivoting movement with the grip; and
a wiring arrangement electrically connecting the switch assembly to the motor and accommodating pivoting movement of the switch assembly with the grip and relative to the motor.

7. The power tool of claim 1, further comprising a compressible member positioned between the rearward end of the body and the second end of the grip to accommodate relative axial movement of the grip and body.

8. The power tool of claim 1, further comprising a locking assembly for locking the grip in a pivoted position relative to the body.

9. The power tool of claim 8, wherein the locking assembly includes a recess defined by one of the body and the grip and a projection provided by an other of the body and the grip, the projection being engageable in the recess to lock the grip in a pivoted position relative to the body.

10. The power tool of claim 8, further comprising a switch assembly operable to electrically connect the motor to a power source, at least a portion of the switch assembly being supported on the grip for pivoting movement with the grip, and wherein the switch assembly is inoperable during pivoting movement of the grip.

11. A power tool comprising:
a spindle for supporting a tool element;
a body defining an axis and housing a motor and a drive mechanism driven by the motor, the drive mechanism selectively driving the spindle, the body having a forward end supporting the spindle and a rearward end;
a grip pivotably connected to the rearward end of the body for pivotable movement about the axis, the grip having a first end and a second end, the first end being engageable by a hand of an operator, the second end being adjacent the rearward end of the body;
a switch assembly operable to electrically connect the motor to a power source, at least a portion of the switch assembly being supported on the grip for pivoting movement with the grip; and
a wiring arrangement electrically connecting the switch assembly to the motor and accommodating pivoting movement of the switch assembly with the grip and relative to the motor.

12. The power tool of claim 11, further comprising:
a fixed conductor on one of the body and the grip; and
a moveable conductor positioned on the other of the body and the grip and moveable with the other of the body and the grip relative to one of the body and the grip, the moveable conductor electrically engaging the fixed conductor to electrically connect the switch assembly to the motor.

13. The power tool of claim 12, wherein the fixed conductor is positioned on the body and electrically connected to the motor, and wherein the moveable conductor is positioned on the grip and is electrically connected to the switch assembly.

14. The power tool of claim 12, wherein the fixed conductor is concentric with the pivot axis, and wherein the moveable conductor is moveable along the fixed conductor.

15. The power tool of claim 11, wherein the switch assembly is inoperable during pivoting movement of the grip about the axis.

16. A power tool comprising:
a spindle for supporting a tool element;
a body housing a motor and a drive mechanism driven by the motor, the drive mechanism selectively driving the spindle, the body having a forward end supporting the spindle and a rearward end;
a grip connected to the rearward end of the body, the grip having a first end engageable by a hand of an operator and a second end adjacent the rearward end of the body; and
a compressible member positioned between the rearward end of the body and the second end of the grip to accommodate relative axial movement between the grip and the body.

17. The power tool of claim 16, wherein the compressible member is an o-ring.

18. The power tool of claim 16, wherein one of the second end of the grip and the rearward end of the body defines a groove extending around at least a portion of the circumference of the one of the second end of the grip and the rearward end of the body, and wherein the compressible member is positioned in the groove.

19. The power tool of claim 16, wherein the grip is pivotable about the axis and relative to the body

20. The power tool of claim 19, wherein the body defines a first axis and the rearward end defines a plane oriented at a non-perpendicular angle relative to the first axis, and wherein the grip is pivotable about a second axis extending through the rearward end of the body and being substantially perpendicular to the plane.

21. The power tool of claim 20, wherein the second end is oriented in the plane.

22. A power tool comprising:
a spindle for supporting a tool element;
a body housing a motor and a drive mechanism driven by the motor, the drive mechanism selectively driving the spindle, the body having a forward end supporting the spindle and a rearward end;
a grip connected to the rearward end of the body for pivoting movement relative to the body, the grip having a first end engageable by a hand of an operator and a second end adjacent the rearward end of the body;
a ring extending around at least a portion of the circumference of one of the rearward end of the body and the second end of the grip; and
a sleeve extending around at least a portion of the circumference of the ring and being between the ring and the other of the rearward end of the body and the second end of the grip.

23. The power tool of claim 22, further comprising a compressible member positioned between the rearward end of the body and the second end of the grip to accommodate relative axial movement between the grip and the body.

24. The power tool of claim 23, wherein one of the second end of the grip and the rearward end of the body define a groove extending around at least a portion of the circumference of the one of the second end of the grip and the rearward end of the body, and wherein the compressible member is positioned in the groove.

25. The power tool of claim 22, wherein at least one of the sleeve and the ring includes a low-friction engaging surface to accommodate pivoting movement of the grip relative to the rearward end of the body.
